(19) United States
(12) Patent Application Publication
(10) Pub. No.: US 2005/0192065 A1
(43) Pub. Date: Sep. 1, 2005

(54) Portable communication device with plural olfactory cuing

(75) Inventors: Tsung-Wei Chiang, Tu-Cheng (TW); Ming-Chiang Tsai, Tu-Cheng (TW); Chun-Yu Lee, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/953,596

(22) Filed: Sep. 29, 2004

(30) Foreign Application Priority Data
Feb. 28, 2004 (CN) 200420043230.8

(51) Int. Cl. H04M 1/00

(52) U.S. Cl. 455/575.1

(57) ABSTRACT

A portable communication device includes a body (11) having a container (111), and a pair of fragrance dispensing apparatuses (12) housed in the container. The body houses main circuitry therein. The container also houses a plurality of electrical connectors therein. The electrical connectors are electrically connected with the main circuitry. Each fragrance dispensing apparatus includes a vessel (121) with a nozzle (127). Each nozzle includes a heater (128) connecting with and being enabled by the main circuitry via the corresponding electrical connector. When the portable communication device receives an incoming call (or message), a predetermined one of the heaters is enabled by the main circuitry to dispense a fragrance corresponding to the caller (or sender).

### BACKGROUND OF THE INVENTION

1. Field of the Invention

The present invention generally relates to portable communication devices such as mobile phones, and more particularly to a portable communication device which has a fragrance dispensing apparatus therein.

2. Prior Art

Currently, portable electronic communication devices provide a variety of means for notifying (cuing) the user of a new incoming call or message. For example, the portable communication device may sound a ring tone, play music, or vibrate. However, if the user is in a meeting or on a noisy street, he/she may not hear the ring tone or music. In addition, if the portable communication device is not beside the user's body, he/she may not feel the vibration.

A mobile phone employing a unit storing fragrance therein can be found in an International Patent No. WO/0215541 issued to Andreas Wuellner and published on Feb. 21, 2002. Using fragrance is an alternative way to cue the user to an incoming call. These mobile phones typically comprise an interchangeable unit provided to couple with mobile support elements. The interchangeable unit is able to store fragrant liquid and release the corresponding fragrance into the environment. Thus when an incoming call is received by a mobile phone, the fragrance can be release into the environment to cue the user. However, this fragrance cuing function does not enable the user to ascertain who the caller is.

Therefore, a portable communication device with fragrance cuing which can differentiate among incoming callers is desired.

### SUMMARY OF THE INVENTION

Accordingly, an object of the present invention is to provide a portable communication device having a fragrance dispensing apparatus therein, which can cue a user regarding different incoming callers using different fragrances.

To achieve the above object, a portable communication device comprises a body including a container. The body houses main circuitry therein. A pair of fragrance dispensing apparatuses is housed in the container. The container also houses a plurality of electrical connectors therein. The electrical connectors are electrically connected with the main circuitry. Each fragrance dispensing apparatus includes a vessel, and each vessel has a nozzle. Each nozzle includes a heater connecting with and being enabled by the main circuitry via the corresponding electrical connector. When the portable communication device receives an incoming call (or message), a predetermined one of the heaters is enabled by the main circuitry to dispense a fragrance corresponding to the caller (or sender).

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of a mobile phone in accordance with a preferred embodiment of the present invention, the mobile phone including two fragrance dispensing apparatuses therein;

FIG. 2 is similar to FIG. 1, but showing the mobile phone viewed from another aspect;

FIG. 3 is an enlarged, isometric view of one of the fragrance dispensing apparatuses of FIG. 1, the fragrance dispensing apparatus including a vessel, the vessel having a nozzle;

FIG. 4 is a cross-sectional view taken along line IV-IV of FIG. 3;

FIG. 5 is an enlarged, schematic, cross-sectional view of an end portion of the nozzle shown in FIG. 4, the nozzle including a heater and an opening and containing fragrant liquid;

FIG. 6 is similar to FIG. 5, but showing some of the fragrant liquid changed into fragrant gas at the heater;

FIG. 7 is similar to FIG. 6, but showing more of the fragrant liquid changed into fragrant gas, thereby pushing some fragrant liquid out through the opening;

FIG. 8 is similar to FIG. 7, but showing the fragrant liquid and the fragrant gas when a complete globule of fragrant liquid has been pushed out of the opening;

FIG. 9 is a flow chart of preferred operation of the mobile phone of FIG. 1; and

FIG. 10 is a schematic diagram of electrical and physical relationships between certain components of the mobile phone of FIG. 1.

### DETAILED DESCRIPTION OF THE INVENTION

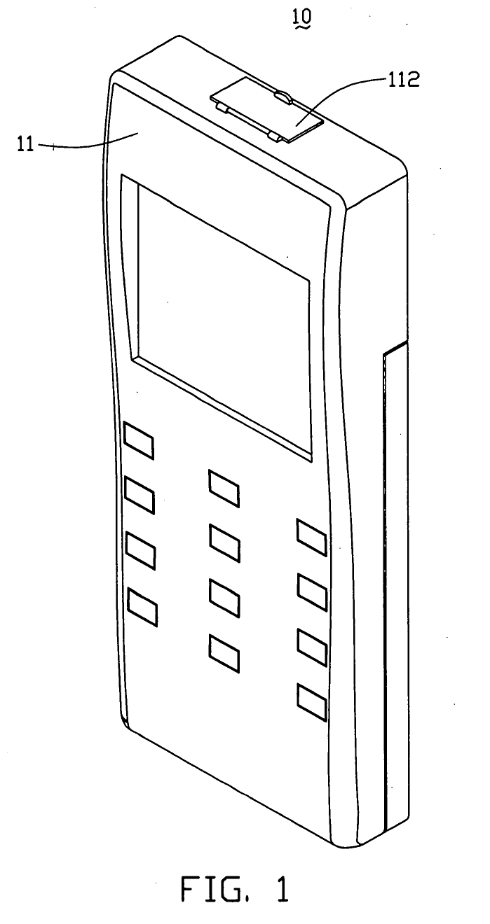

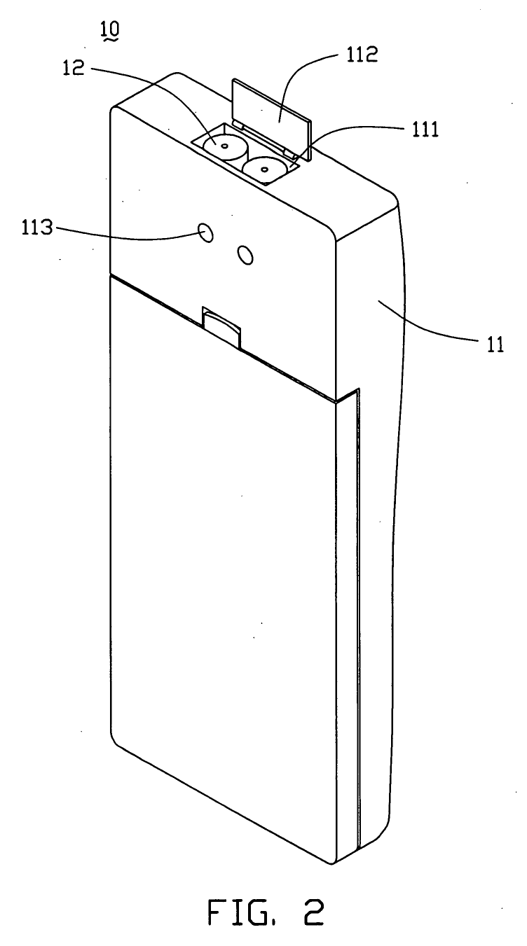

A portable communication device in the preferred embodiment of the present invention is a mobile phone 10. Referring to FIGS. 1 and 2, the mobile phone 10 includes a body 11 and two fragrance dispensing apparatuses 12.

The body 11 includes a container 111 in one end thereof, a container cover 112 rotatably mounted on said end by a hinge (not labeled), and a pair of holes 113 defined in a main wall of the body 11 at the container 111. The container 111 defines an opening (not labeled) in said end of the body 11 at the hinge. The container 111 includes a plurality of pedestals (not shown) in a bottom thereof, and a plurality of electrical connectors (not shown) is provided on the pedestals. The electrical connectors are electrically coupled with main circuitry (not shown) of the mobile phone 10 in the body 11. The cover 112 is hinged near the opening of the container 111, and can cover the opening. The fragrance dispensing apparatuses 12 are received in the container 111, fixed on the pedestals, and covered by the cover 112. Each fragrance dispensing apparatus 12 engages with a corresponding one of the electrical connectors, so that it is electrically connected with the main circuitry of the mobile phone 10.

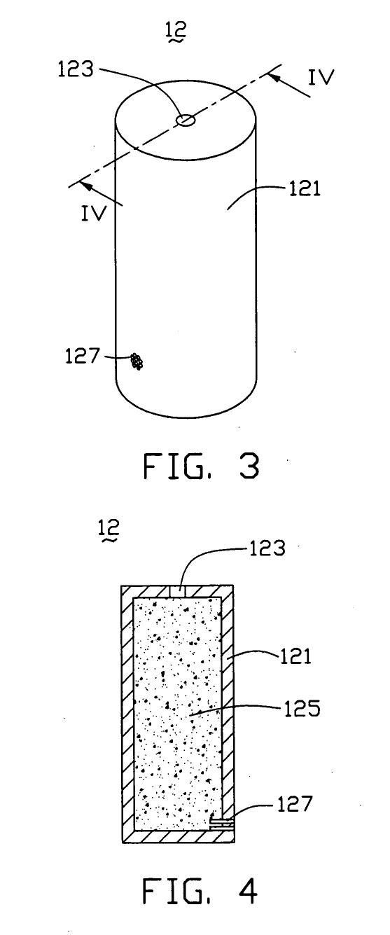

Referring to FIGS. 3 and 4, each fragrance dispensing apparatus 12 includes a vessel 121 containing a core 125 therein. The vessel 121 also includes an entrance 123 in a top thereof, and at least one nozzle 127 at a bottom thereof. The core 125 is made of a material which has good liquid absorbing capability. An inner end of the nozzle 127 is embedded in the core 125, and an outer end of the nozzle 127 has an opening in a sidewall of the vessel 121. Fragrant liquid is stored in the core 125. When the fragrant liquid is completely used up, a user can insert new fragrant liquid into the core 125 with an injector.

Referring to FIG. 5, the nozzle 127 comprises a heater 128 in a wall thereof. In the preferred embodiment, the heater 128 is a resistance heater. When the fragrance dispensing apparatus 12 is installed in the container 111, the heater 128 is connected with one of the electrical connectors. The main circuitry of the mobile phone 10 can thus send out a pulse signal 1006 (see FIG. 10) to enable the heater 128. In general, the nozzle 127 is full of fragrant liquid. The nozzle 127 is very thin, so that the fragrant liquid is retained therein without effusing out.

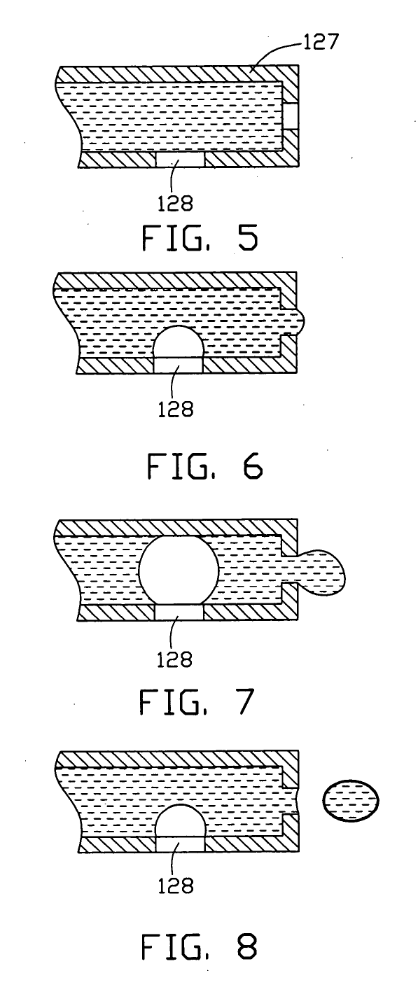

Referring to FIGS. 6, 7 and 8, when the heater 128 is enabled by a pulse signal 1006, the temperature of the heater 128 rises to 300 degrees Centigrade immediately. Some of the fragrant liquid near the heater 128 changes to fragrant gas and expands. The gas pushes some of the fragrant liquid near the opening of the nozzle 127 out through the opening. This fragrant liquid then exits the mobile phone 10 through a corresponding one of the holes 113. In addition, because the pulse signal 1006 is very short and the heating temperature is high, the gas near the heater 128 rapidly expands, so that it obstructs liquid located far from the opening from reaching the opening. Thus only a predetermined amount of the fragrant liquid is released from the opening, with no wastage.

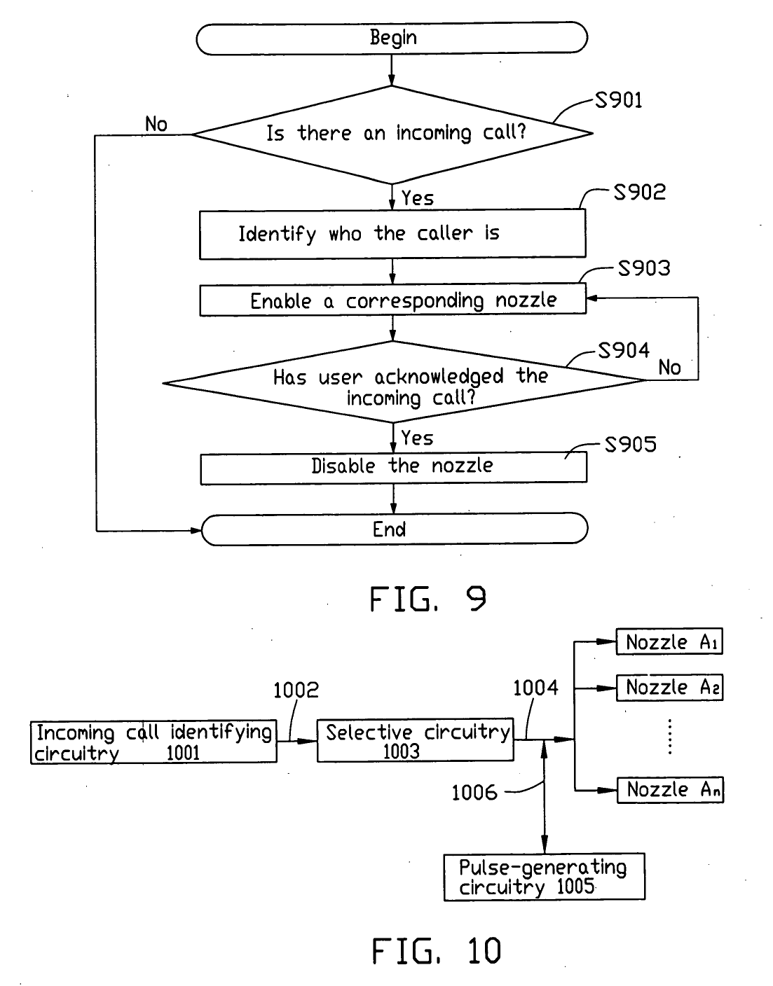

Referring to FIG. 9, the user programs the mobile phone 10 so that each of pre-identified senders is assigned a particular fragrance according to fragrant liquid contained in a corresponding fragrance dispensing apparatus 12. The function of cuing the user regarding incoming calls according to fragrance is thus enabled. In the following description, it will be assumed that any incoming call (or message) is from a pre-identified caller (or sender), and not from a previously unknown caller (or sender). When an incoming call arrives at the mobile phone 10, the main circuitry controls the fragrance dispensing apparatuses 12 as follows. First, in step S901, the main circuitry determines whether there is an incoming call. If there is no incoming call, the procedure is ended. If there is an incoming call, in step S902, the main circuitry identifies who the caller is. Then in step S903, the main circuitry sends a pulse signal 1006 to the nozzle 127 of a corresponding fragrance dispensing apparatus 12. Next, in step S904, the main circuitry determines whether there is a signal or answering message which indicates that the user has acknowledged the incoming call. If the user has not acknowledged the incoming call, the procedure returns to step S903. If and when the user has acknowledged the incoming call, in step S905, the main circuitry disables the nozzle 127 of the corresponding fragrance dispensing apparatus 12, whereupon the procedure is ended. In other words, until the user acknowledges the incoming call, the nozzle of the corresponding fragrance dispensing apparatus 12 is continually enabled by pulse signals 1006, so that the nozzle 127 emits enough fragrance for the user to be successfully cued regarding the incoming call.

Referring to FIG. 10, the main circuitry includes incoming call identifying circuitry 1001, selective circuitry 1003, and pulse-generating circuitry 1005. In step S902 described above in relation to FIG. 9, the incoming call identifying circuitry 1001 sends out a control signal 1002 to the selective circuitry 1003. Then in step S903, the selective circuitry 1003 sends out a pulse signal 1004 to a corresponding one of the nozzles 127, i.e. A1 or A2 (or An in the case where there may be more than two fragrance dispensing apparatuses 12 with nozzles 127), and to the pulse-generating circuitry 1005. Then the pulse-generating circuitry 1005 sends out a pulse signal 1006 to enable the heater of the corresponding nozzle 127.

It is to be understood that in various alternative embodiments of the present invention, the container 111 may be provided in the body 11 in any suitable position. Further, one, three, or more fragrance dispensing apparatuses 12 may be employed. When two or more fragrance dispensing apparatuses 12 are employed, they may be separately distributed in the body 11, or they may be integrated together. Further, the described electrical connectors may be integrated into a single electrical connector.

It is believed that the present invention and its advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

1. A portable communication device, comprising:
a body comprising main circuitry therein and a container, said container having electrical connector means electrically coupled with said main circuitry; and
a fragrance dispensing apparatus contained in said container, and comprising at least two vessels, each vessel having a nozzle; wherein
each nozzle comprises a heater electrically connecting with and being enabled by said main circuitry via said electrical connector means, whereby when said portable communication device receives an incoming call or message, said heater can be enabled by said main circuitry to dispense a corresponding fragrance out from said fragrance dispensing apparatus.

2. The portable communication device as claimed in claim 1, wherein said body further comprises at least one through hole in a wall thereof at said container.

3. The portable communication device as claimed in claim 2, wherein said body further comprises a cover mounted thereon at said container, said cover covering an opening of said container.

4. The portable communication device as claimed in claim 1, further comprising at least one pedestal at a bottom of said container, wherein said electrical connector means is provided at said pedestal, and said pedestal with said electrical connector means holds said fragrance dispensing apparatus thereon.

5. The portable communication device as claimed in claim 1, wherein each vessel further has an entrance at one end thereof.

6. The portable communication device as claimed in claim 5, wherein each vessel further has a core for storing fragrant liquid therein.

7. The portable communication device as claimed in claim 6, wherein said core is made of material which has good liquid absorbing capability.

8. The portable communication device as claimed in said claim 1, wherein said heater is a resistance heater.

9. The portable communication device as claimed in said claim 1, wherein said main circuitry comprises incoming call identifying circuitry for identifying an incoming call or message.

10. The portable communication device as claimed in said claim 9, wherein said main circuitry further comprises selective circuitry for sending a pulse signal to a corresponding nozzle.

11. The portable communication device as claimed in said claim 10, wherein said main circuitry further comprises pulse-generating circuitry enabled by said selective circuitry.

12. A method for olfactorily cuing a user of a portable communication device regarding an incoming call or message, comprising the steps of:
receiving the incoming call or message;
identifying a sender of the incoming call or message;
enabling a fragrance dispenser of said portable communication device which is associated with said sender according to preset instructions;
determining whether the user has acknowledged the incoming call or message, and returning to step c. if the user has not acknowledged the incoming call or message; and
disabling said fragrance dispenser if and when the user has acknowledged the incoming call or message.

13. A method for identifying an incoming message of a portable communication device, comprising the steps of:
providing more than one fragrance source in said portable communication device;
identifying said incoming message; and
enabling one of said more than one fragrance source to release predetermined fragrance therefrom based on said identified massage.

14. The method as claimed in said claim 13, further comprising a step of terminating said fragrance-release of said one of said more than one fragrance source after receipt of an answering message of said portable communication device.

15. The method as claimed in said claim 13, further comprising a step of recording pre-identifying information in said portable communication device as a base of said identifying step.
